(19) United States
(12) Patent Application Publication
(10) Pub. No.: US 2019/0114849 A1
(43) Pub. Date: Apr. 18, 2019

(54) METHOD FOR DIAGNOSING NOISE CAUSE OF A VEHICLE

(71) Applicants: HYUNDAI MOTOR COMPANY, Seoul (KR); KIA Motors Corporation, Seoul (KR)

(72) Inventors: Dong Chul Lee, Anyang-si (KR); In Soo Jung, Suwon-si (KR)

(73) Assignees: HYUNDAI MOTOR COMPANY, Seoul (KR); KIA Motors Corporation, Seoul (KR)

(21) Appl. No.: 15/825,673

(22) Filed: Nov. 29, 2017

(30) Foreign Application Priority Data
Oct. 16, 2017 (KR) 10-2017-0133858

(51) Int. Cl. G07C 5/08; G06N 5/04; G06F 17/30; G01N 29/14; G01N 29/04; G01M 17/007

(52) U.S. Cl. CPC G07C 5/0808; G06N 5/04; G06F 17/30076; G10K 2210/1282; G01N 29/048; G01M 17/007; G01N 29/14

(57) ABSTRACT

A method for diagnosing a cause of noise of a vehicle is disclosed. The method includes receiving, by a controller, a sound source signal through a microphone installed in the vehicle. The method further includes transmitting, by the controller, the received sound source signal to an artificial intelligence server and extracting, by the artificial intelligence server, reference data corresponding to the sound source signal by comparing the received sound source signal with stored reference data. Additionally, the method includes transmitting, by the artificial intelligence server, the extracted reference data to the controller and outputting, by the controller, to a diagnostic apparatus, an output signal including information about the cause of noise of the vehicle based on the received reference data.

### CROSS-REFERENCE TO RELATED APPLICATION

This application claims the priority benefit of Korean Patent Application No. 10-2017-0133858, filed on Oct. 16, 2017 in the Korean Intellectual Property Office, the entire contents of which is fully incorporated by reference herein.

### BACKGROUND

### 1. Field

The present disclosure relates to a method for easily diagnosing a cause of noise of a vehicle by comparing sound information generated in a vehicle with data in an artificial intelligence server.

### 2. Description of the Related Art

Generally, the noise generated from the engine, the transmission, etc. mounted on a vehicle is diagnosed by a person by listening to the noise or by performing individual analysis after measuring the overall noise of the vehicle.

However, in this case, the cost and the labor cost rate required to identify the cause of a problem with the vehicle are increased, and only an expert can accurately identify the cause of the problem with the vehicle. Thus, it is difficult for average persons to identify the problem with the vehicle.

It should be understood that the foregoing description of the background art is merely for the purpose of promoting an understanding of the background of the present invention and is not to be construed as an admission that the present invention corresponds to the prior art known to those skilled in the art.

### SUMMARY

Therefore, the present disclosure has been made in view of the above problems, and it is an object of the present disclosure to provide a method for diagnosing a cause of noise of a vehicle by analyzing, through an artificial intelligence server, a sound source signal received from a microphone provided in a vehicle and precisely identifying the cause of noise of the vehicle.

In accordance with an aspect of the present disclosure, the above and other objects can be accomplished by a method for diagnosing a cause of noise of a vehicle, the method including receiving, by a controller, a sound source signal through a microphone installed in the vehicle, after the receiving, transmitting, by the controller, the received sound source signal to an artificial intelligence server and extracting, by the artificial intelligence server, reference data corresponding to the sound source signal from a pre-stored reference data map by comparing the received sound source signal with the reference data map, and after the extracting, transmitting, by the artificial intelligence server, the extracted reference data to the controller and outputting, by the controller, to a diagnostic apparatus, an output signal including information about the cause of noise of the vehicle based on the received reference data.

The microphone may be installed in an interior of the vehicle or on a side of an engine.

The extracting may include converting, by the artificial intelligence server, the received sound source signal into image data and comparing the converted image data with the reference data map to extract the corresponding reference data.

The artificial intelligence server may convert the sound source signal into the image data using a Gabor filter and a Mel filter.

The extracting may include converting, by the artificial intelligence server, the received sound source signal into a specific parameter using a neural network and comparing the converted specific parameter with the reference data map to extract the corresponding reference data.

The neural network may be a convolutional neural network (CNN) or a deep neural network (DNN) additionally using engine RPM (revolutions per minute) data.

The extracting may include extracting, by the artificial intelligence server, the reference data using sound source information for an entire time of the received single sound source signal.

The extracting may include converting, by the artificial intelligence server, the received sound source signal into image data, converting the converted image data into a specific parameter using a neural network, and comparing the converted specific parameter with the reference data to extract the corresponding reference data.

The reference data may include information on a plurality of vehicle components causing noise and noise association ratio information on the vehicle components, wherein the outputting may include the controller outputting the output signal to the diagnostic apparatus such that the plurality of vehicle components is listed in descending order of noise association ratios based on the received reference data.

According to the method for diagnosing the cause of noise of a vehicle having the above-described structure, the cost and the labor cost rate required to identify the cause of noise when a problem occurs in the vehicle may be reduced.

Further, the method enables average persons who do not have expertise to easily identify the cause of noise of a vehicle.

### BRIEF DESCRIPTION OF THE DRAWINGS

Exemplary aspects are illustrated in the drawings. It is intended that the embodiments and figures disclosed herein are to be considered illustrative rather than restrictive.

FIG. 1 is a flowchart illustrating a method for diagnosing a cause of noise of a vehicle according to an embodiment of the present application;

FIG. 2 is a block diagram illustrating an apparatus for diagnosing a cause of noise of a vehicle according to an embodiment of the present application; and

FIG. 3 illustrates operation of a diagnostic apparatus according to an embodiment of the present application.

### DETAILED DESCRIPTION

Reference will now be made in detail to various embodiments of a method for diagnosing a cause of noise of a vehicle of the present invention, examples of which are illustrated in the accompanying drawings. Wherever possible, the same reference numbers will be used throughout the drawings to refer to the same or like parts.

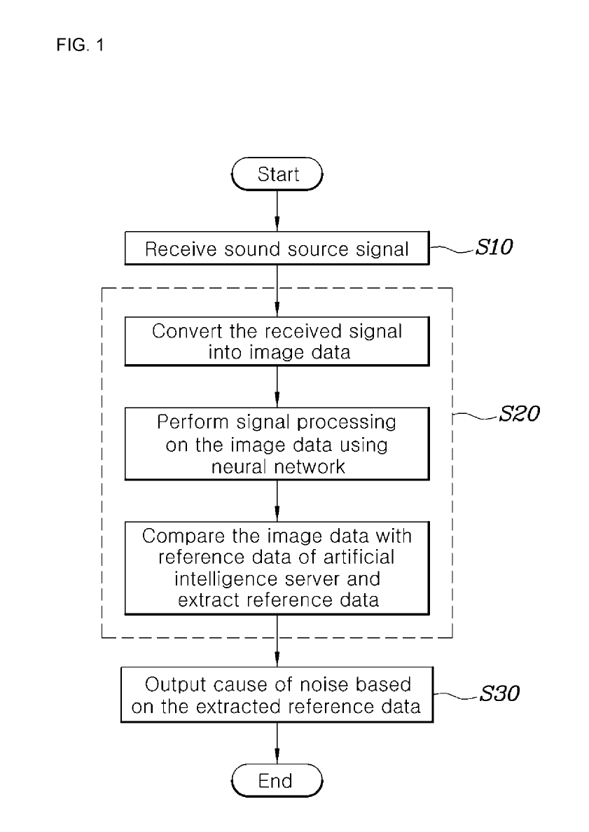

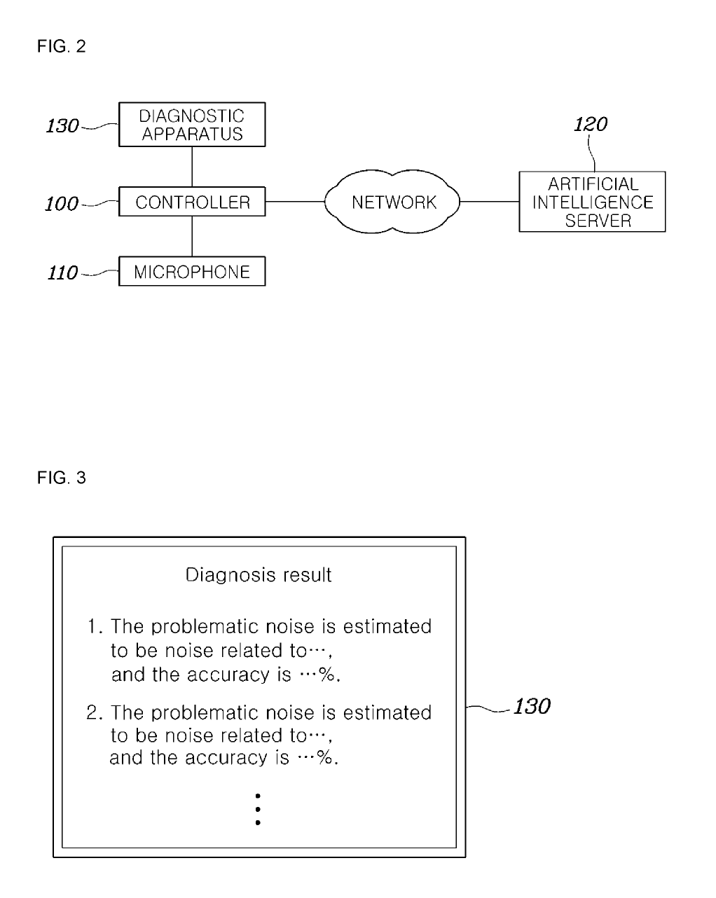

FIG. 1 is a flowchart illustrating a method for diagnosing a cause of noise of a vehicle according to an embodiment of the present disclosure, and FIG. 2 is a block diagram illustrating an apparatus for diagnosing a cause of noise of a vehicle according to an embodiment of the present invention.

Referring to FIGS. 1 and 2, a method for diagnosing a cause of noise of a vehicle may include a controller 100 receiving a sound source signal through a microphone 110 installed in the vehicle at step S10. After the reception step S10, the controller 100 transmits the received sound source signal to an artificial intelligence server 120. The artificial intelligence server 120 then compares the received sound source signal with a pre-stored reference data map and extracts reference data corresponding to the sound source signal from the reference data map at step S20. After the extraction step S20, the artificial intelligence server 120 transmits the extracted reference data to the controller 100 and the controller 100 outputs an output signal including information about the cause of noise of the vehicle based on the received reference data at step S30 to a diagnostic apparatus 130.

First, when the owner of the vehicle or a mechanic carries out a diagnosis of a noise cause of the vehicle through the diagnostic apparatus 130, the controller 100 performs the reception step S10.

The microphone 110 is installed in the vehicle. Specifically, the microphone 110 may be installed in the interior of the vehicle or on the side of the engine. Therefore, the controller 100 may receive sound from the interior of the vehicle having a passenger riding therein, sound generated from the engine room, and the like, through the microphone 110 as sound source signals.

The controller 100 that has collected a sound source signal through the reception step S10 transmits the sound source signal to the artificial intelligence server 120. The artificial intelligence server 120 compares the received sound source signal with a pre-stored reference data map and extracts reference data corresponding to the sound source signal.

The artificial intelligence server 120 collects noise data according to various failure situations, and classifies the same into deep learning-based big data types to secure a reference data map having a plurality of mapped reference data. Thereafter, when a sound source signal is received from the controller 100, the artificial intelligence server 120 compares the sound source signal with the reference data map and extracts reference data having characteristics similar to that of a noise cause according to the sound source signal at S20.

Here, the artificial intelligence server 120 may be provided in the form of a Web server such that the owner of the vehicle or the mechanic can easily access the server to diagnose the noise.

When the artificial intelligence server 120 extracts the reference data, the controller 100 transmits the reference data to the controller 100, and the controller 100 outputs noise cause information about the vehicle to the diagnostic apparatus 130 based on the received reference data, such that the owner of the vehicle or the mechanic can identify the cause of the noise of the vehicle through the diagnostic apparatus 130.

Preferably, the diagnostic apparatus 130 includes a display unit so that the driver or mechanic can identify the cause of the noise of the vehicle. The information on the cause of the noise of the vehicle may be output to the display unit.

More specifically, in the extraction step S20, the artificial intelligence server 120 may convert the received sound source signal into image data, and then compare the converted image data with the reference data map to extract corresponding reference data.

That is, the artificial intelligence server 120 may convert the sound source signal of a sound type into image data of an image type on the basis of time or frequency, and compare the feature vector representing the converted image data into the reference data map, thereby extracting reference data of the corresponding noise type. Preferably, the reference data stored in the artificial intelligence server 120 is provided in the form of images.

By converting the sound source signal into image data and extracting the corresponding reference data as described above, a specific noise may be extracted from the sound source signal, which is a mixture of various noise sources, to perform deep learning or to perform analysis by accurately comparing the noise with the corresponding reference data.

The artificial intelligence server 120 may convert the sound source signal into image data using a Gabor filter and a Mel filter.

Alternatively, in the extraction step S20, the artificial intelligence server 120 may convert the received sound source signal into a specific parameter using a neural network, and then compare the converted specific parameter with the reference data, thereby extracting corresponding reference data.

Here, the neural network may be a convolutional neural network (CNN) or a deep neural network (DNN) or additionally using engine RPM data.

The DNN and the CNN are neural networks that improve accuracy of artificial intelligence machine learning. The DNN and the CNN time/frequency-filter sound source signals and then classify the same into noise types by specific parameters such as vehicle location or vehicle component.

Accordingly, the artificial intelligence server 120 may distinguish between various types of noise from the sound source signal by extracting reference data corresponding to the converted specific parameters and perform comparison and analysis, thereby improving the discrimination power and accuracy of analysis of the cause of the vehicle noise.

Further, the neural networks may further discriminate the characteristics of a noise source resulting from the revolutions per minute (RPM) of the engine from a noise source which does not result from the RPM by additionally applying the engine RPM information in order to reflect a special condition for distinguishing between the vehicle noise sources. Therefore, the accuracy of noise source classification in the vehicle may be improved.

Meanwhile, in the extraction step S20, the artificial intelligence server 120 may extract the reference data using the sound source information for the entire time of the received single sound source signal.

Conventional artificial intelligence algorithms generate learning models in units of 20-40 sec using a formulaic sound source signal (30 seconds) and perform learning using the corresponding result. However, this degrades the capability of distinguishing between noise sources in the sound source signal having various mixed sound sources such as vehicle noise sources.

In consideration of this, the present technology may improve the accuracy of the learning model and accurately extract the reference data by applying a learning algorithm using long-term learning of the entirety of one sound source signal. Therefore, both the noise source generated in a short time and the noise source generated in a long time may be learned.

Alternatively, in the method for diagnosing a cause of noise of a vehicle, in the extraction step S20, the artificial intelligence server 120 may convert the received sound source signal into image data, convert the converted image data into a specific parameter using a neural network, and then compare the converted specific parameter with the reference data to extract the corresponding reference data.

That is, since the artificial intelligence server 120 performs conversion of the sound source signal received from the controller 100 in two steps and then compares the sound source signal with the reference data for analysis, the artificial intelligence server 120 may accurately distinguish between the noise types based on the feature vectors of the image data and have the advantage of the neural network for distinguishing between various types of noise. Therefore, the cause of noise of the vehicle may be diagnosed accurately and distinguishably.

Here, the reference data may include information on a plurality of vehicle components that cause noise and noise association ratio information on the vehicle components. In the output step S30, the controller 100 may output an output signal to the diagnostic apparatus 130 such that the plurality of vehicle components is listed in descending order of noise association ratios based on the received reference data.

FIG. 3 illustrates operation of a diagnostic apparatus 130 according to one embodiment. Referring to FIG. 3, the controller generates an output signal based on the reference data received from the artificial intelligence server, and transmits the same to output, through the display unit of the diagnostic apparatus 130, information indicating whether the noise of the vehicle corresponds to the noise of specific vehicle components and the noise association ratio of the corresponding vehicle components.

Here, the reference data includes a vehicle location causing noise and noise association ratio information about the location, in addition to information on a plurality of vehicle components causing noise and noise association ratio information.

Accordingly, the owner of the vehicle or a mechanic may easily identify which of the plurality of vehicle components is related to the cause of the noise by checking the display unit of the diagnostic apparatus 130.

As is apparent from the above description, according to the method for diagnosing the cause of noise of a vehicle having the above-described structure, the cost and the labor cost rate required to identify the cause of noise when a problem occurs in the vehicle may be reduced.

Further, the method enables average persons who do not have expertise to easily identify the cause of noise of a vehicle.

While a number of exemplary aspects have been discussed above, those of skill in the art will recognize that still further modifications, permutations, additions and sub-combinations thereof of the disclosed features are still possible. It is therefore intended that the following appended claims and claims hereafter introduced are interpreted to include all such modifications, permutations, additions and sub-combinations as are within their true spirit and scope.

What is claimed is:

1. A method for diagnosing a cause of noise of a vehicle, the method comprising:
receiving, by a controller, a sound source signal through a microphone installed in the vehicle;
after the receiving, transmitting, by the controller, the received sound source signal to an artificial intelligence server and extracting, by the artificial intelligence server, reference data corresponding to the sound source signal from a pre-stored reference data map by comparing the received sound source signal with the reference data map; and
after the extracting, transmitting, by the artificial intelligence server, the extracted reference data to the controller and outputting, by the controller, to a diagnostic apparatus, an output signal including information about the cause of noise of the vehicle based on the received reference data.

2. The method according to claim 1, wherein the microphone is installed in an interior of the vehicle or on a side of an engine.

3. The method according to claim 1, wherein the extracting comprises:
converting, by the artificial intelligence server, the received sound source signal into image data and comparing the converted image data with the reference data map to extract the corresponding reference data.

4. The method according to claim 3, wherein the artificial intelligence server converts the sound source signal into the image data using a Gabor filter and a Mel filter.

5. The method according to claim 1, wherein the extracting comprises:
converting, by the artificial intelligence server, the received sound source signal into a specific parameter using a neural network and comparing the converted specific parameter with the reference data map to extract the corresponding reference data.

6. The method according to claim 5, wherein the neural network is a convolutional neural network (CNN) or a deep neural network (DNN) additionally using engine revolutions per minute (engine RPM) data.

7. The method according to claim 5, wherein the extracting comprises:
extracting, by the artificial intelligence server, the reference data using sound source information for an entire time of the received single sound source signal.

8. The method according to claim 1, wherein the extracting comprises:
converting, by the artificial intelligence server, the received sound source signal into image data, converting the converted image data into a specific parameter using a neural network, and comparing the converted specific parameter with the reference data to extract the corresponding reference data.

9. The method according to claim 1, wherein the reference data comprises information on a plurality of vehicle components causing noise and noise association ratio information on the vehicle components,
wherein the outputting comprises:
outputting, by the controller, the output signal to the diagnostic apparatus such that the plurality of vehicle components is listed in descending order of noise association ratios based on the received reference data.

10. The method according to claim 3, wherein the reference data comprises information on a plurality of vehicle components causing noise and noise association ratio information on the vehicle components,
wherein the outputting comprises:
outputting, by the controller, the output signal to the diagnostic apparatus such that the plurality of vehicle components is listed in descending order of noise association ratios based on the received reference data.

11. The method according to claim 5, wherein the reference data comprises information on a plurality of vehicle components causing noise and noise association ratio information on the vehicle components,
wherein the outputting comprises:
outputting, by the controller, the output signal to the diagnostic apparatus such that the plurality of vehicle components is listed in descending order of noise association ratios based on the received reference data.

12. The method according to claim 8, wherein the reference data comprises information on a plurality of vehicle components causing noise and noise association ratio information on the vehicle components,
wherein the outputting comprises:
outputting, by the controller, the output signal to the diagnostic apparatus such that the plurality of vehicle components is listed in descending order of noise association ratios based on the received reference data.
